(19) United States
(12) Patent Application Publication
(10) Pub. No.: US 2022/0114997 A1
(43) Pub. Date: Apr. 14, 2022

(54) INFORMATION PROCESSING APPARATUS, INFORMATION PROCESSING METHOD, AND PROGRAM

(71) Applicant: SONY GROUP CORPORATION, TOKYO (JP)

(72) Inventors: NAOYA TAKAHASHI, TOKYO (JP); WEIHSIANG LIAO, TOKYO (JP)

(21) Appl. No.: 17/415,199

(22) PCT Filed: Nov. 7, 2019
(86) PCT No.: PCT/JP2019/043586

§ 371 Date: Jun. 17, 2021

(30) Foreign Application Priority Data
Dec. 27, 2018 (JP) 2018-244718

(51) Int. Cl. G10K 11/178; H04R 3/00

(52) U.S. Cl. CPC G10K 11/17883; G10K 11/17857; H04R 3/005; H04R 2203/12; G10K 2210/1281; G10K 2210/1082; G10K 2210/3215; G10K 11/17881

(57) ABSTRACT

An information processing apparatus including a noise reduction unit that reduces noise generated from an unmanned aerial vehicle, included in an audio signal picked up by a microphone mounted on the unmanned aerial vehicle, on the basis of state information on a noise source.

### TECHNICAL FIELD

The present disclosure relates to an information processing apparatus, an information processing method, and a program.

### BACKGROUND ART

Microphones mounted on unmanned aerial vehicles referred to as UAVs are used to pick up sounds generated from objects located on the ground surface etc. Sounds recorded by a UAV can be significantly degraded in the signal-to-noise ratio (S/N ratio) in the recording of the sounds due to the loud noise of the motor(s), the propeller(s), etc. generated by the UAV itself. Therefore, as methods for improving the S/N ratio of signals obtained, a method of forming directivity toward a target sound source using a plurality of microphones, and a method of installing microphones above and below the propeller(s) of a UAV at an equal distance to estimate noise as described in Patent Document 1 have been proposed.

### CITATION LIST

### Patent Document

Patent Document 1: Japanese Patent Application Laid-Open No. 2017-213970

### SUMMARY OF THE INVENTION

### Problems to be Solved by the Invention

However, the technology described in Patent Document 1 only forms gentle directivity in the downward direction of the UAV, and the influence of wind noise increases the possibility that noise cannot be sufficiently reduced. Furthermore, the size of a microphone array that can be mounted on UAVs is often limited, and thus sufficient directivity may not be obtained.

It is an object of the present disclosure to provide an information processing apparatus, an information processing method, and a program capable of reducing noise.

### Solutions to Problems

The present disclosure is, for example,

an information processing apparatus including:

a noise reduction unit that reduces noise generated from an unmanned aerial vehicle, included in an audio signal picked up by a microphone mounted on the unmanned aerial vehicle, on the basis of state information on a noise source.

The present disclosure is, for example,

an information processing method including:

reducing, by a noise reduction unit, noise generated from an unmanned aerial vehicle, included in an audio signal picked up by a microphone mounted on the unmanned aerial vehicle, on the basis of state information on a noise source.

The present disclosure is, for example,

a program that causes a computer to perform an information processing method including:

reducing, by a noise reduction unit, noise generated from an unmanned aerial vehicle, included in an audio signal picked up by a microphone mounted on the unmanned aerial vehicle, on the basis of state information on a noise source.

### BRIEF DESCRIPTION OF DRAWINGS

FIG. 1 is a block diagram for explaining a configuration example of a UAV according to one embodiment.

FIG. 2 is a diagram schematically showing a transfer function from a target sound source to a microphone of each UAV, and others.

FIG. 3 is a diagram that is referred to in an explanation of a third processing example in one embodiment.

FIG. 4 is a diagram that is referred to in an explanation of a modification of a fourth processing example in one embodiment.

FIGS. 5A and 5B are diagrams that are referred to in an explanation of a specific example of a fifth processing example in one embodiment.

### MODE FOR CARRYING OUT THE INVENTION

Hereinafter, an embodiment etc. of the present disclosure will be described with reference to the drawings. Note that the description will be made in the following order.

### One Embodiment

<Modifications>

The embodiment etc. described below are suitable specific examples of the present disclosure, and the subject matter of the present disclosure is not limited to the embodiment etc.

### One Embodiment

[UAV Configuration Example]

First, a configuration example of a UAV that is an example of an information processing apparatus will be described. The UAV flies autonomously or according to user control, and acquires sounds generated from objects located on the ground surface etc. and images of the objects. Note that processing performed by the UAV described below may alternatively be performed by a personal computer, a tablet computer, a smartphone, a server device, or the like. That is, these electronic devices mentioned as examples may be the information processing apparatus in the present disclosure.

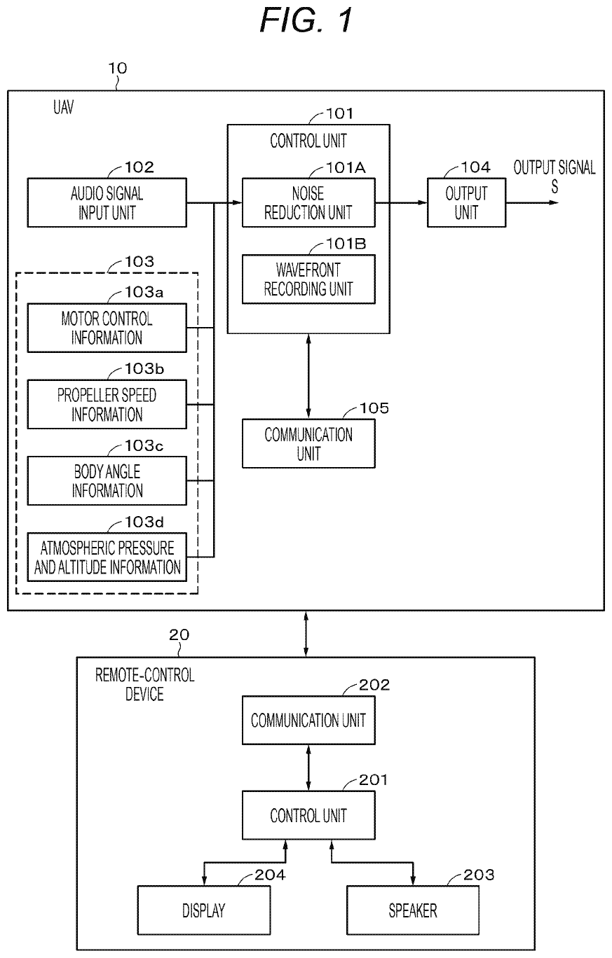

FIG. 1 is a block diagram for explaining a configuration example of a UAV (UAV 10) according to one embodiment. Note that in the following description, a configuration of the UAV 10 related mainly to audio processing will be described. The UAV 10 may include a known configuration for processing images etc.

The UAV 10 includes, for example, a control unit 101, an audio signal input unit 102, an information input unit 103, an output unit 104, and a communication unit 105.

The control unit 101 includes a central processing unit (CPU), and centrally controls the entire UAV 10. The UAV 10 includes a read-only memory (ROM) in which a program executed by the control unit 101 is stored, a random-access memory (RAM) used as a working memory when the program is executed, etc. (these are not shown in the figure).

Further, the control unit 101 includes, as its functions, a noise reduction unit 101A and a wavefront recording unit 101B.

The noise reduction unit 101A reduces noise generated from the UAV 10 which is included in an audio signal picked up by a microphone mounted on the UAV 10, on the basis of state information on a noise source (noise reduction). Specifically, the noise reduction unit 101A reduces non-stationary noise generated by the UAV 10 (which means noise that varies according to the state of the UAV 10, unlike stationary noise that is generated with certain regularity).

The wavefront recording unit 101B records a wavefront in a closed surface surrounded by a plurality of UAVs 10, using microphones mounted on the plurality of respective UAVs 10. Note that details of processing performed by the noise reduction unit 101A and the wavefront recording unit 101B, individually, will be described later.

The audio signal input unit 102 is, for example, a microphone that records sounds emitted by objects (including persons) located on the ground surface etc. An audio signal picked up by the audio signal input unit 102 is input to the control unit 101.

The information input unit 103 is an interface to which various types of information are input from sensors that the UAV 10 has. The information input to the information input unit 103 is, for example, state information on a noise source. The state information on the noise source includes information on a control signal to a drive mechanism that drives the UAV 10, and body state information including at least one of the state of the UAV 10 or the state around the UAV 10. As shown in FIG. 1, specific examples of the information on the control signal to the drive mechanism include motor control information 103a for driving the motor(s) of the UAV 10 and propeller control information 103b for controlling the propeller speed of the UAV 10. Specific examples of the body state information include body angle information 103c indicating the angle of the body of the UAV 10 which indicates the state of the UAV 10, and atmospheric pressure and altitude information 104d indicating the state around the UAV 10. Each piece of information obtained via the information input unit 103 is input to the control unit 101. These pieces of information can be both waveform data and a spectrum.

The output unit 104 is an interface that outputs an audio signal processed by the control unit 101. An output signal s is output from the output unit 104. Note that the output signal s may be transmitted to a personal computer, a server device, or the like via the communication unit 105. In this case, the communication unit 105 operates as the output unit 104.

The communication unit 105 is configured to communicate with a device located on the ground surface or a network in response to the control of the control unit 101. The communication may be wired communication, but in the present embodiment, wireless communication is assumed. The wireless communication may be a local-area network (LAN), Bluetooth (registered trademark), Wi-Fi (registered trademark), Wireless USB (WUSB), or the like. An audio signal processed by the control unit 101 is transmitted to an external device via the communication unit 105. Further, a signal input via the communication unit 105 is input to the control unit 101.

FIG. 1 shows a remote-control device 20 that controls the UAV 10. The remote-control device 20 includes, for example, a control unit 201, a communication unit 202, a speaker 203, and a display 204. The remote-control device 20 is configured as, for example, a personal computer.

A configuration of the remote-control device 20 will be schematically described. The control unit 201 includes a CPU or the like, and centrally controls the entire remote-control device 20. The communication unit 202 is configured to communicate with the UAV 10. The speaker 203 outputs, for example, sounds that have been processed by the UAV 10 and received by the communication unit 202. The display 204 displays various types of information.

[Examples of Processing Performed in UAV]

Next, multiple processing examples performed in the UAV 10 will be described. Note that in processing involving a plurality of UAVs 10, one of the plurality of UAVs 10 may acquire signals obtained by the plurality of UAVs 10, individually, and then perform processing described below, or a device other than the plurality of UAV 10 (for example, the remote-control device 20 or a server device) may acquire signals obtained by the plurality of UAVs 10, individually, and then perform the processing described below.

### First Processing Example

A first processing example is an example in which the noise reduction unit 101A reduces noise included in an audio signal picked up by the audio signal input unit 102 on the basis of the state information on the noise source. Note that processing related to the first processing example can be performed by each UAV 10 alone.

In the first processing example, body noise is separated and reduced, using a neural network, for an input audio signal acquired by the audio signal input unit 102 mounted on the UAV 10, specifically, the microphone. The microphone may be one or a plurality of microphones. The Fourier transform of the input audio signal X(c, t, f) can be expressed as

X(c,t,f)=N(c,t,f)+ΣᵢHⁱSⁱ(c,t,f)

where c, t, and f are a microphone channel, a time frame, and a frequency index, respectively, N is body noise, Sⁱ is an i-th sound source, and Hⁱ is a transfer function from the i-th sound source to the microphone. For the learning of a noise reduction neural network, learning data can be artificially generated for use, using the body noise N recorded in the absence of a target sound source and a transfer function measured in advance. The noise reduction neural network can be learned to separate a target sound source from the input signal X. As correct answer data for learning, sound source data Sⁱ(c, t, f) before the transfer function is convolved thereto, the average Σ_{I, c}HⁱSⁱ(c, t, f) of signals picked up by the microphone, or the like can be used.

The above is a typical sound source separation method. For the UAV 10, however, the S/N ratio is very low, and thus sufficient performance may not be obtained by the typical method. In this case, it is conceivable to improve performance using various types of information regarding the UAV 10. Noise is mainly caused by the motor(s) and the wind noise of the propeller(s). These have a strong correlation with the rotation speed of the motor(s). Thus, by using the rotation speed of the motor(s) or a motor control signal, noise can be estimated more accurately. Furthermore, in a case where the control signal is used, the rotation speed of the motor(s) varies due to an external force. As factors that determine (vary) the external force, atmospheric pressure, wind, humidity, etc. can be considered. Information such as a change in altitude as a factor that changes atmospheric pressure, and the speed and inclination of the body as factors that cause wind or factors for wind detection can be used. That is, by simultaneously providing signals based on these pieces of state information on the noise source as inputs to the neural network, more accurate noise removal becomes possible.

For the learning of the neural network, for example, the following loss function L_{θ} is minimized to learn.

L_{θ}=|HⁱSⁱ(c,t,f)−F(X(c,t,f),Ψ(t),θ|²

where F is a function learned by the neural network, θ is a network parameter, and Ψ(t) is information obtained via the information input unit 103 in the time frame t, which is represented by a vector, a matrix, a scalar quantity, or the like.

The noise reduction unit 101A performs an operation on an input audio signal using the learning result.

According to the first processing example described above, a target sound can be recorded even under conditions of high-level noise of the propeller sound and the motor sound (under a low S/N ratio). By using the state information on the noise source, the amount of signal read-ahead can be reduced to allow noise reduction processing with low delay.

### Second Processing Example

In a case where a plurality of UAVs 10 is used, beamforming can be performed using microphones mounted on the respective UAVs 10 to further improve the S/N ratio. That is, in a second processing example, the noise reduction unit 101A performs beamforming using the microphones mounted on the plurality of respective UAVs 10, to reduce noise included in audio signals.

The specifics of the processing will be described. For example, a minimum variance distortionless response (MVDR) beamformer is expressed by the following equations:

$$\hat{S} = W$$

$$W = \frac{{R}^{- 1} a}{{a}^{H} {R}^{- 1} a}$$

W in the above equations is beamforming filter coefficients. By setting W properly as shown below, beamforming can be performed in an intended direction (for example, toward a target sound source), and signals from the target sound source can be emphasized.

Here,

Ŝ∈

[symbol]

is an output of the beamformer,

W∈ [symbol] ^{N×1}

is beamformer coefficients,

X∈ [symbol] ^{N}

is input audio signals,

a∈ [symbol] ^{N}

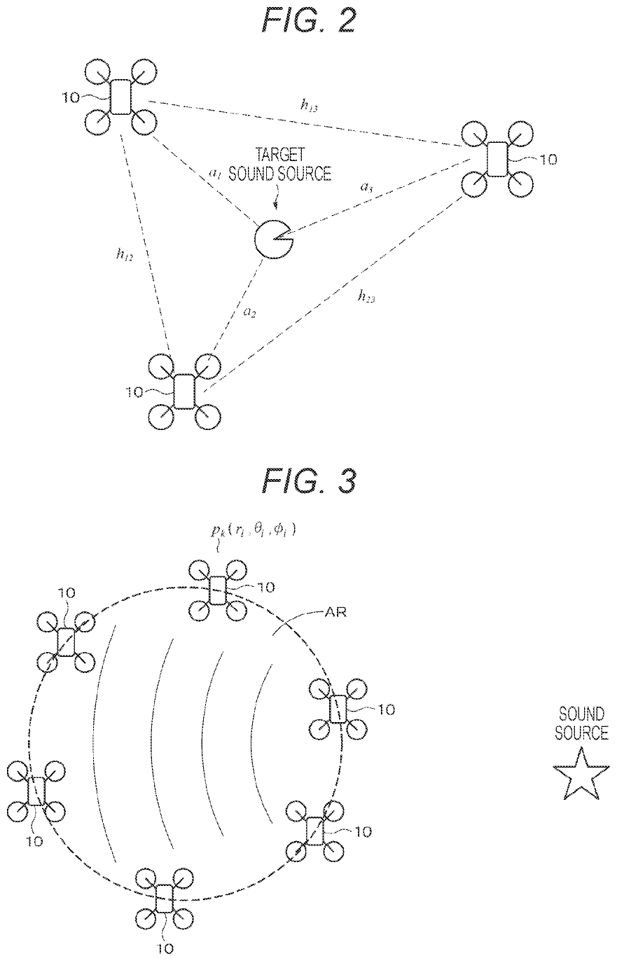

is transfer functions (or steering vectors) from a sound source targeted for sound pickup to the respective microphones (see FIG. 2),

R∈ [symbol] ^{N×N}

is a noise correlation matrix, and

N is the number of microphones.

In a case where each microphone is mounted on the UAV 10 itself, a is determined by the positional relationship between the sound source and the UAV 10, and thus needs to be determined successively as the positions of the sound source and the UAV 10 move. For the positions of the sound source and the UAV 10, stereo vision, a distance sensor, image information, a global positioning system (GPS) system, distance measurement by an inaudible sound such as ultrasonic waves, or the like can be applied. For example, a is approximately determined according to the distance to the target sound source.

However, since the UAV 10 is flying in the air, it is difficult to determine its position with complete accuracy. Further, in a case where the target sound source is followed or a case where the UAV 10 moves according to user operation or by autonomous movement or the like, the accuracy of the position estimation of the UAV 10 relative to a predetermined position deteriorates in proportion to the moving speed. Specifically, the faster the moving speed, the larger the moving distance between the current time and the next time, and the larger the position estimation error. Therefore, it is desirable to set coefficients in beamforming processing, taking into account position estimation errors to the positions of the UAVs 10 estimated in advance. Furthermore, for example, of UAVs 10 equidistant from the sound source, a stationary UAV 10 has a small position estimation error. Thus, it is desirable to determine the coefficient in such a manner as to make its weight of contribution to beamforming larger than those of UAVs 10 moving at high speed. This can be achieved by, for example, introducing a probabilistic model to the position estimation of the UAVs 10.

For example, assume that a signal model is

x=as+Hn

Letting a target audio signal recorded by each microphone of the corresponding UAV 10 be

\tilde{s}=as

and,

letting the probability distributions of a noise signal

ñ=Hn

be

\tilde{s}˜N(sμ,Σ),n˜N(0,\tilde{R}),

respectively, then, the posterior distribution P(x|s) of a mixed signal can be expressed by the following equation:

P(x|s)=N(sμ,Σ)+N(b,\tilde{R})=N(sμ,Σ+\tilde{R})

can be expressed, where

μ∈ [symbol] ^{N}

is the transfer function of the UAV 10 at an estimated position, Σ is a variance due to a position estimation error, and

\tilde{R}

is a spatial correlation matrix of noise.

μ∈ [symbol] ^{N}

can be expressed as

$${μ}_{i} = \frac{C}{{r}_{i}^{2}} exp ( j ω {r}_{i} / c )$$

if a free space (a space without reflection) is assumed. rᵢ is the distance between the target sound source and the i-th microphone, c is the speed of sound, and C is a constant. Σ is determined by position estimation accuracy and assumed volume, and can be determined experimentally in advance. For example, the variance can be determined from the difference between a transfer function determined using a method by which the position of the UAV 10 can be determined accurately using an external camera or the like as a preliminary experiment, and a transfer function calculated from position information that is determined using a sensor actually used and a position information estimation algorithm. If the variance is determined as a function of velocity, for example, a small variance can be used when the UAV 10 is stationary, and a large variance value when the UAV 10 is moving at high speed. Noise statistics can be determined experimentally in advance. Details will be described later.

The least squares solution to the equation expressing the posterior distribution P(x|s) of the mixed signal described above can be found by the following equation:

ŝ=(μ^{T}(Σ+\tilde{R})⁻¹μ)⁻¹μ(Σ+\tilde{R})⁻¹x

This equation shows that the beamformer coefficients are calculated according to the uncertainty of the positions of the UAVs 10. Further, if there is no position uncertainty, in other words, letting Σ=0, the above equation shows that it results in an MVDR beamformer.

The spatial correlation matrix of a noise signal can be expressed as

\tilde{R}=E[n^{H}H^{H}Hn]

n is mainly the propeller sounds and the motor sounds of the UAVs 10, and H depends only on the distance between the UAVs 10 if a free space is assumed, and thus can be measured in advance. Furthermore, the distance between each microphone mounted on the UAV 10 and self-noise is generally several centimeters to several tens of centimeters, and the distance between the UAVs 10 is often several meters. Thus, diagonal elements hᵢᵢ of the transfer function H=[hᵢⱼ] have a larger absolute value than off-diagonal elements. Furthermore, if all the UAVs 10 have the same body shape, hᵢᵢ=h₀, and the approximation H≈h₀I can be made.

Therefore, the approximation

\tilde{R}≈|h₀|²E[n^{H}n]

can be made to allow an approximation in a correlation matrix that does not depend on the positions of the UAVs 10.

Note that other than a linear beamformer, a nonlinear neural beamformer or the like can be applied to this processing example.

The second processing example described above may be performed together with the first processing example. For example, a signal that has been subjected to the noise reduction processing in the first processing example may be used as an input in the second processing example.

According to the second processing example described above, by using a plurality of UAVs 10, target sound can be recorded with a lower noise level (with a higher S/N ratio). Even if the accurate positions of the UAVs 10 are unknown and errors are included, beamforming is performed with high accuracy, taking into account expected variances of errors, so that a target sound can be recorded with a high S/N ratio.

### Third Processing Example

A third processing example is processing to record a wavefront in a closed surface surrounded by a plurality of UAVs 10, using microphones installed on the plurality of UAVs 10. The processing example shown below is performed by, for example, the wavefront recording unit 101B. As shown in FIG. 3, consider recording a wavefront in a closed surface AR surrounded by a plurality of UAVs 10. Assume that there is no sound source targeted for sound pickup in the closed surface AR. If each UAV 10 is stationary, and the position of each UAV 10 is known accurately, with the position of the i-th UAV 10 as (rᵢ, θᵢ, φᵢ), the spherical harmonics aₘₙ(k) representing a wavefront can be expressed, using a transformation matrix Mₖ and signals pₖ observed by the microphones, as

$${a}_{mn} ( k ) = {M}_{k}^{†} {p}_{k}$$

$${p}_{k} = [ \begin{matrix}{p}_{k} ( {r}_{0} , {θ}_{0} , {ϕ}_{0} ) \\ {p}_{k} ( {r}_{1} , {θ}_{1} , {ϕ}_{1} ) \\ ⋮ \\ {p}_{k} ( {r}_{L} , {θ}_{L} , {ϕ}_{L} )\end{matrix} ] , L = Q - 1$$

$${M}_{k} [ \begin{matrix}{j}_{0} ( {kr}_{0} ) {Y}_{0}^{0} ( {θ}_{0} , {ϕ}_{0} ) & {j}_{0} ( {kr}_{0} ) {Y}_{1}^{- 1} ( {θ}_{0} , {ϕ}_{0} ) & … & {j}_{N} ( {kr}_{0} ) {Y}_{N}^{N} ( {θ}_{0} , {ϕ}_{0} ) \\ ⋮ & ⋮ & & ⋮ \\ {j}_{0} ( {kr}_{L} ) {Y}_{0}^{0} ( {θ}_{L} , {ϕ}_{L} ) & {j}_{1} ( {kr}_{L} ) {Y}_{1}^{- 1} ( {θ}_{L} , {ϕ}_{L} ) & … & {j}_{N} ( {kr}_{L} ) {Y}_{N}^{N} ( {θ}_{L} , {ϕ}_{L} )\end{matrix} ]$$

where k is a wave number, jₙ is a sphere Bessel function,

Yₙ^{m}

is a spherical harmonic function, Q is the number of microphones, and † is a pseudo-inverse matrix.

In actuality, the position estimation of the UAVs 10 causes errors for the reason explained in the second processing example. With a position estimation error as (Δrᵢ, Δθᵢ, Δφᵢ), the transformation matrix

Mₖ^{Est}

be expressed as follows:

$${M}_{k}^{Est} = [ \begin{matrix}{j}_{0} ( k ( {r}_{0} + Δ {r}_{0} ) ) {Y}_{0}^{0} ( {θ}_{0} + Δ {θ}_{0} , {ϕ}_{0} + Δ {ϕ}_{0} ) & {j}_{N} ( k ( {r}_{0} + Δ {r}_{0} ) ) {Y}_{N}^{N} ( {θ}_{0} + Δ {θ}_{0} , {ϕ}_{0} + Δ {ϕ}_{0} ) \\ ⋮ & ⋮ \\ {j}_{0} ( k ( {r}_{L} + Δ {r}_{L} ) ) {Y}_{0}^{0} ( {θ}_{L} + Δ {θ}_{L} , {ϕ}_{L} + {Δϕ}_{L} ) & {j}_{N} ( k ( {r}_{L} + Δ {r}_{L} ) ) {Y}_{N}^{N} ( {θ}_{L} + Δ {θ}_{L} , {ϕ}_{L} + Δ {ϕ}_{L} )\end{matrix} ]$$

Thus, an error δMₖ in the transformation matrix can be expressed as

δMₖ=Mₖ−Mₖ^{Est}

Using an error δp from an ideal state, sound pressure observed by the microphones of the UAVs 10 including the other noise n is

p+δp=(M+δM)a+n

p=Ma,a=M^{†}p

from which, the error can be expressed as

δp=δMM^{†}p+n

∥AX+B∥≤∥A∥∥X∥+∥B∥

from which,

∥δp∥≤∥δM∥∥M^{†}∥∥p∥+∥n∥

On the other hand, the condition number of the transformation matrix M can be expressed as

κ(M)=∥M∥∥M^{†}∥

and so, the expression

$$\frac{‖ {δ}_{p} ‖}{‖ p ‖} \leq κ ( M ) \frac{‖ {δ}_{M} ‖}{‖ M ‖} + \frac{‖ n ‖}{‖ p ‖}$$

can be made.

From this equation, for example, if it is desired that the ratio of a reconstructed sound pressure error be R or less, the condition number k(M) must satisfy

$$κ ( M ) \leq ( R - \frac{‖ p ‖}{‖ n ‖} ) \frac{‖ M ‖}{‖ {δ}_{M} ‖} = C$$

For example, if

$$\frac{‖ {δ}_{M} ‖}{‖ M ‖}$$

is 0.5,

$$\frac{‖ n ‖}{‖ p ‖}$$

is 0.01, and

it is desired to keep the ratio R of the sound pressure error to 0.2 or less, k(M) needs to be 3.8 or less. To satisfy this, a regularization term can be added to the inverse matrix calculation of the transformation matrix M. For example, the transformation matrix M is subjected to the singular value decomposition, and of eigenvalues, all eigenvalues that are

$$\frac{{σ}_{max}}{C} = \frac{{σ}_{max}}{3.8}$$

or less are replaced with zero for regularization. The regularized matrix is applied to an operation to find spherical harmonics. Here, σmax is the maximum value of the eigenvalues. By performing this processing, a transformation matrix with a desired sound pressure error can be obtained.

M=UΣV*

M^{†}=V\tilde{Σ}⁻¹U*

where Σ is a matrix in which the eigenvalues are arranged diagonally in descending order, and

\tilde{Σ}⁻¹

is a matrix in which inverse matrix elements of Σ corresponding to eigenvalues less than or equal to

$$\frac{{σ}_{max}}{R}$$

are replaced with zero.

Note that as another method, a method called Tikhonov regularization can be applied. This is a method in which letting

M^{†}=(M^{H}M+λI)⁻¹

the minimum λ that results in

∥M∥∥M^{†}∥<C

is found for regularization.

According to the third processing example, even if the positions of the UAVs 10 are not completely accurate, a wavefront can be stably recorded by the microphones mounted on the UAVs 10, taking into account position estimation errors.

### Fourth Processing Example

A fourth processing example is processing to change the arrangement of UAVs 10 so that a higher S/N ratio can be obtained according to the coefficients and output of the beamformer obtained in the second processing example described above, and image information. This processing may be performed autonomously by the UAV 10 (specifically, the control unit 101 of the UAV 10), or may be performed by the control of a personal computer or the like different from the UAV 10. For example, with an MVDR beamformer, the arrangement of the UAVs 10 is changed by moving the UAVs 10 in a direction to decrease the energy PN of beamformed noise output.

The MVDR beamformer output of noise can be expressed as

$${P}_{N} = {W}^{H} n {n}^{H} W = \frac{1}{{a}^{H} {\tilde{R}}^{- 1} a}$$

Assuming a free space and a point sound source, a can be expressed as

$${a}_{i} = \frac{C}{{\vert {r}_{s r c} - {r}_{i} \vert}^{2}} exp ( j ω \vert {r}_{src} - {r}_{i} \vert / c )$$

(where r_{src} is the position vector of a target sound source, and rᵢ is the position vector of the i-th UAV 10.), and thus, to minimize this, the UAV 10 is moved to

$$- \frac{\partial {P}_{N}}{\partial r}$$

that is the gradient direction of the position vector r. R can be determined as in the second processing example.

However, in actuality, there are limitations in the target sound source and the distance between the UAVs 10, and thus an optimal

rₒₚₜ∈U

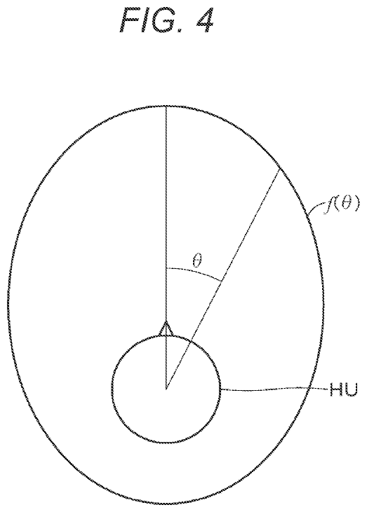

under these limiting conditions U is calculated. Further, by modeling the radiation characteristics of a sound source and determining model parameters from a sound or an image, the S/N ratio can be maximized with higher accuracy. For example, since a human voice has a stronger radiation characteristic in the front direction than in the back direction as shown schematically in FIG. 4, a strong radiation characteristic may be assumed for the front of the face of a person HU, and by determining the angle θ of the face from an image, a transfer function may be multiplied by a weighting function f(θ) to the transfer function for calculation.

Further, the UAVs 10 may be rearranged according to the result of the wavefront recording of the wavefront recording unit 101B.

According to the fourth processing example described above, the UAVs 10 automatically move to positions where a sound or a wavefront can be recorded with a high S/N ratio, allowing recording with higher sound quality and lower noise.

### Fifth Processing Example

A fifth processing example is an example in which control to add a UAV(s) 10 is performed in a case where a plurality of UAVs 10 is used and it is determined that sufficient beamforming performance cannot be obtained or wavefront recording cannot be performed by the above-described processing with the current number of UAVs 10, for example. Still, the fifth processing example is an example in which control such as moving an unnecessary UAV(s) 10 away is performed in a case where a plurality of UAVs 10 is used and it is determined that sufficient beamforming performance is obtained, or noise generated by a UAV(s) 10 is affecting another (other) UAV(s) 10, for example. That is, the fifth processing example is an example to optimize the output of beamforming or to increase or decrease the number of UAVs 10 located in a predetermined area, on the basis of the result of wavefront recording by the wavefront recording unit 101B. Note that not sufficient means, for example, that noise has not become a threshold value or below, a change in S/N before and after noise reduction has not become a threshold value or below.

A specific example of the fifth processing example will be described. For example, when it is determined that sufficient noise reduction performance cannot be obtained by the gradient-based method described above, or when it is determined that sufficient wavefront sound collection performance cannot be obtained, a UAV 10 group can be controlled to add a UAV(s) 10. For example, when extensive recording is performed with a plurality of UAVs 10, many UAVs 10 are not required in a silent area, and UAVs 10 can be concentrated in another area where beamforming is in a difficult condition. A condition in which beamforming is difficult may be a case where noise is large, or a condition in which recording must be performed from a distance because of a no-fly zone of UAVs 10 for safety reasons, or the like.

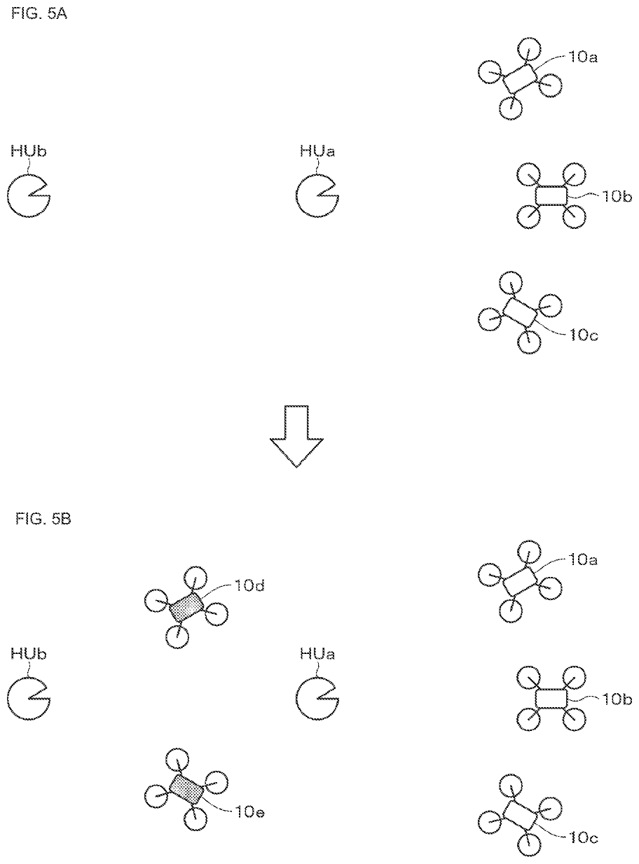

Another specific example will be described. As shown in FIG. 5A, in a case where a speaker HUa and a speaker Hub are in the same direction relative to three UAVs 10 (UAVs 10a to 10c), the arrival directions of sounds are almost the same, and thus separation is difficult with beamforming. Therefore, as shown in FIG. 5B, by newly disposing, for example, two UAVs 10 (UAVs 10d and 10e) between the speakers HUa and HUb, signals different in the arrival directions of sounds from the two speakers are obtained, so that only the signal from the speaker HUa can be extracted.

According to the fifth processing example described above, many UAVs 10 can be arranged around a required target sound source, and UAVs 10 can be moved away from unrequired positions, so that recording with a high S/N ratio is made possible, and UAVs 10 can be operated efficiently according to a sound source position, the number of sound sources, etc.

<Modifications>

Although the embodiment of the present disclosure has been described above, the present disclosure is not limited to the above-described embodiment, and various modifications can be made without departing from the spirit of the present disclosure.

The operation in each of the above-described processing examples is an example, and the processing in each processing example may be implemented by another operation. Further, the processing in each of the above-described processing examples may be performed independently or together with the other processing. Further, the configuration of the UAVs is an example, and a known configuration may be added to the UAVs in the embodiment.

The present disclosure can also be implemented by a device, a method, a program, a system, etc. For example, by making the program to perform the functions described in the above-described embodiment downloadable, and downloading and installing the program in a device that does not have the functions described in the embodiment, the device can perform the control described in the embodiment. The present disclosure can also be implemented by a server that distributes such a program. Furthermore, matters described in each of the embodiment and the modifications can be combined as appropriate. Moreover, the effects illustrated in the present description do not limit the interpretation of the contents of the present disclosure.

The present disclosure may also adopt the following configurations.

(1)

An information processing apparatus including:

a noise reduction unit that reduces noise generated from an unmanned aerial vehicle, included in an audio signal picked up by a microphone mounted on the unmanned aerial vehicle, on the basis of state information on a noise source.

(2)

The information processing apparatus according to (1), in which

the state information on the noise source includes body state information including at least one of a state of the unmanned aerial vehicle or a state around the unmanned aerial vehicle.

(3)

The information processing apparatus according (1) or (2), in which

the noise reduction unit reduces the noise included in the audio signal by performing beamforming using microphones mounted on a plurality of the respective unmanned aerial vehicles.

(4)

The information processing apparatus according to (3), in which

the noise reduction unit determines coefficients in processing of the beamforming, taking into account position estimation errors of the unmanned aerial vehicles relative to a predetermined position.

(5)

The information processing apparatus according to (4), in which

the noise reduction unit changes the coefficients according to moving speeds of the respective unmanned aerial vehicles.

(6)

The information processing apparatus according to any one of (1) to (5), further including:

a wavefront recording unit that records a wavefront in a closed surface surrounded by a plurality of the unmanned aerial vehicles, using microphones mounted on the plurality of respective unmanned aerial vehicles.

(7)

The information processing apparatus according to (6), in which

the wavefront recording unit determines coefficients of spherical harmonics for recording the wavefront in the closed surface, taking into account position estimation errors of the unmanned aerial vehicles relative to a predetermined position.

(8)

The information processing apparatus according to any one of (3) to (7), in which

the vehicles' positions are rearranged so that output of the beamforming is optimized.

(9)

The information processing apparatus according to (8), in which

the vehicles' positions are rearranged in a direction to reduce energy of noise caused by the beamforming.

(10)

The information processing apparatus according to any one of (3) to (9), in which

the number of unmanned aerial vehicles in a predetermined area is increased or decreased to optimize output of the beamforming.

(11)

The information processing apparatus according to (6), in which

the number of unmanned aerial vehicles in a predetermined area is increased or decreased on the basis of a result of the recording of the wavefront by the wavefront recording unit.

(12)

The information processing apparatus according to any one of (1) to (11), in which

the noise reduction unit reduces non-stationary noise generated from the unmanned aerial vehicle.

(13)

The information processing apparatus according to any one of (1) to (12),

configured as the unmanned aerial vehicle.

(14)

An information processing method including:

reducing, by a noise reduction unit, noise generated from an unmanned aerial vehicle, included in an audio signal picked up by a microphone mounted on the unmanned aerial vehicle, on the basis of state information on a noise source.

(15)

A program that causes a computer to perform an information processing method including:

reducing, by a noise reduction unit, noise generated from an unmanned aerial vehicle, included in an audio signal picked up by a microphone mounted on the unmanned aerial vehicle, on the basis of state information on a noise source.

### REFERENCE SIGNS LIST

10 UAV
101 Control unit
101A Noise reduction unit
101B Wavefront recording unit
102 Audio signal input unit
103 Information input unit

1. An information processing apparatus comprising:
a noise reduction unit that reduces noise generated from an unmanned aerial vehicle, included in an audio signal picked up by a microphone mounted on the unmanned aerial vehicle, on a basis of state information on a noise source.

2. The information processing apparatus according to claim 1, wherein
the state information on the noise source includes body state information including at least one of a state of the unmanned aerial vehicle or a state around the unmanned aerial vehicle.

3. The information processing apparatus according to claim 1, wherein
the noise reduction unit reduces the noise included in the audio signal by performing beamforming using microphones mounted on a plurality of the respective unmanned aerial vehicles.

4. The information processing apparatus according to claim 3, wherein
the noise reduction unit determines coefficients in processing of the beamforming, taking into account position estimation errors of the unmanned aerial vehicles relative to a predetermined position.

5. The information processing apparatus according to claim 4, wherein
the noise reduction unit changes the coefficients according to moving speeds of the respective unmanned aerial vehicles.

6. The information processing apparatus according to claim 1, further comprising:
a wavefront recording unit that records a wavefront in a closed surface surrounded by a plurality of the unmanned aerial vehicles, using microphones mounted on the plurality of respective unmanned aerial vehicles.

7. The information processing apparatus according to claim 6, wherein
the wavefront recording unit determines coefficients of spherical harmonics for recording the wavefront in the closed surface, taking into account position estimation errors of the unmanned aerial vehicles relative to a predetermined position.

8. The information processing apparatus according to claim 3, wherein
the vehicles' positions are rearranged so that output of the beamforming is optimized.

9. The information processing apparatus according to claim 8, wherein
the vehicles' positions are rearranged in a direction to reduce energy of noise caused by the beamforming.

10. The information processing apparatus according to claim 3, wherein
the number of unmanned aerial vehicles in a predetermined area is increased or decreased to optimize output of the beamforming.

11. The information processing apparatus according to claim 6, wherein
the number of unmanned aerial vehicles in a predetermined area is increased or decreased on a basis of a result of the recording of the wavefront by the wavefront recording unit.

12. The information processing apparatus according to claim 1, wherein
the noise reduction unit reduces non-stationary noise generated from the unmanned aerial vehicle.

13. The information processing apparatus according to claim 1,
configured as the unmanned aerial vehicle.

14. An information processing method comprising:
reducing, by a noise reduction unit, noise generated from an unmanned aerial vehicle, included in an audio signal picked up by a microphone mounted on the unmanned aerial vehicle, on a basis of state information on a noise source.

15. A program that causes a computer to perform an information processing method comprising:
reducing, by a noise reduction unit, noise generated from an unmanned aerial vehicle, included in an audio signal picked up by a microphone mounted on the unmanned aerial vehicle, on a basis of state information on a noise source.
